(19) United States
(12) Patent Application Publication
(10) Pub. No.: US 2017/0148061 A1
(43) Pub. Date: May 25, 2017

(54) METHOD AND APPARATUS FOR WIRELESS FUEL PRICE ADVERTISING AND FULFILLMENT

(71) Applicant: FORD GLOBAL TECHNOLOGIES, LLC, Dearborn, MI (US)

(72) Inventors: Oliver LEI, Windsor (CA); Allen R. MURRAY, Lake Orion, MI (US)

(21) Appl. No.: 14/949,263

(22) Filed: Nov. 23, 2015

(51) Int. Cl. G06Q 30/02; H04W 76/00; H04W 4/00

(52) U.S. Cl. CPC G06Q 30/0266; H04W 4/008; H04W 76/002

(57) ABSTRACT

A system includes a processor configured to wirelessly receive and store identification information received from a vehicle, in response to a transmitted fuel offer being wirelessly transmitted to the vehicle. The processor is also configured to provide a price for fuel in accordance with a stored record of the transmitted fuel offer, in response to the vehicle's wirelessly received identification information matching information associated with the stored record.

### TECHNICAL FIELD

The illustrative embodiments generally relate to a method and apparatus for wireless fuel price advertising and fulfillment.

### BACKGROUND

For decades drivers have played the game of deciding if “today is a good day to buy gas.” Gasoline prices tend to fluctuate daily, so if a driver does not need fuel (i.e., the tank is not low), the only real incentive to bring a driver into a gas station is a good deal on a price. Of course, if prices have dropped to a good-deal level, drivers may think the prices are going to drop more. Since most drivers don't actually track the commodities underlying gas prices, they tend to make uneducated guesses about which direction gas prices are headed. And, if prices rise, they may be incentivized to “wait it out” and see if the prices fall back to previous levels.

This can create a headache for station owners, because they are incentivized to put the price as low as possible to lure in drivers, but as can be seen, even low prices might not be enough to lure in the driver who doesn't “need” gas. At the same time, by pricing the gas at a low level, they need high volume to maintain profits, and they're losing money on the drivers that “needed” the gas and would have bought the fuel regardless of price (within reason). If the stations could more reasonably ensure an inflow of customers, they could more comfortably price the fuel at a lower level, knowing the volume would make up for any loss in profit per transaction.

### SUMMARY

In a first illustrative embodiment, a system includes a processor configured to wirelessly receive and store identification information received from a vehicle, in response to a transmitted fuel offer being wirelessly transmitted to the vehicle. The processor is also configured to provide a price for fuel in accordance with a stored record of the transmitted fuel offer, in response to the vehicle's wirelessly received identification information matching information associated with the stored record.

In a second illustrative embodiment, a system includes a processor configured to create a record of identification information and a fuel offer, when identification is wirelessly received in response to the processor wirelessly broadcasting the fuel offer to a passing vehicle and the vehicle owner electing to lock-in the offer for a predetermined period.

In a third illustrative embodiment, a system includes a processor configured to wirelessly receive a fuel offer from a station past which a vehicle travels. The processor is also configured to store the offer and an accompanying expiration date in a vehicle memory. The processor is further configured to determine that the vehicle is parked at the station based on vehicle location information and wirelessly transmit offer identifying information for offer redemption in response to the vehicle being parked at the station.

### BRIEF DESCRIPTION OF THE DRAWINGS

FIG. 1 shows an illustrative vehicle computing system;

FIG. 2 shows an illustrative example of an offer delivery process;

FIG. 3 shows an illustrative example of an offer redemption process;

FIG. 4 shows an illustrative example of an offer update process;

FIG. 5 shows an illustrative example of an offer determination process; and

FIG. 6 shows an illustrative example of an offer adjustment process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

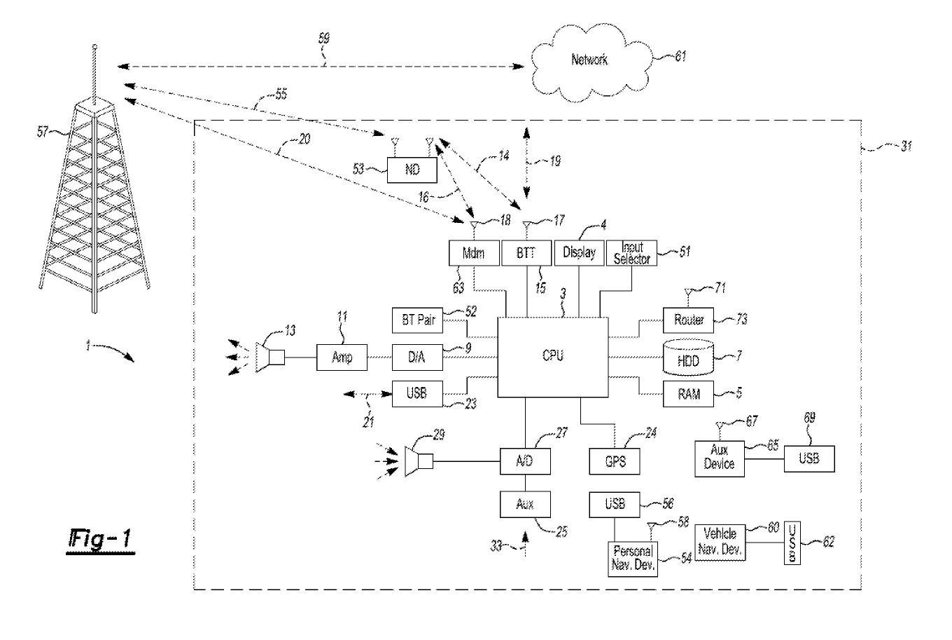

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 k Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 Mbps for stationary or walking users and 385 kbps for users in a moving vehicle. 3G standards are now being replaced by IMT-Advanced (4G) which offers 100 Mbps for users in a vehicle and 1 Gbps for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device.

Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

The illustrative embodiments present a solution whereby a driver can “lock in” a fuel price when driving past a gas station. The price is broadcast to the driver via dedicated short range communication (DSRC), for example, a wireless spectrum provided for automotive use. The vehicle can track the price to remind the driver of the offer, which will expire after some period of time. The station also receives vehicle information (such as the VIN) so that the station can keep a record of the offer for when the driver returns to redeem the price. Although examples are provided referring to fuel, the same concepts could be applied to electric power and/or parking space time at recharging stations.

In some examples, the station owner may even offer to match any lower price that occurs within the next week, in order to incentivize the drivers to utilize the offer immediately. This can be done, for example, by providing a credit (in the form of a refund or discount on a next-purchase). In this manner, a customer is incentivized to either return to a gas station to refuel a vehicle, and/or to utilize the offer immediately, knowing that for at least a prescribed period of time, the price will be “guaranteed.”

In the illustrative examples, when a vehicle travels past a gas station, short range wireless communication between the vehicle and the station occurs. Relevant information to the offer is transferred between the vehicle and the station, and any necessary data to redeem the offer is stored by either party.

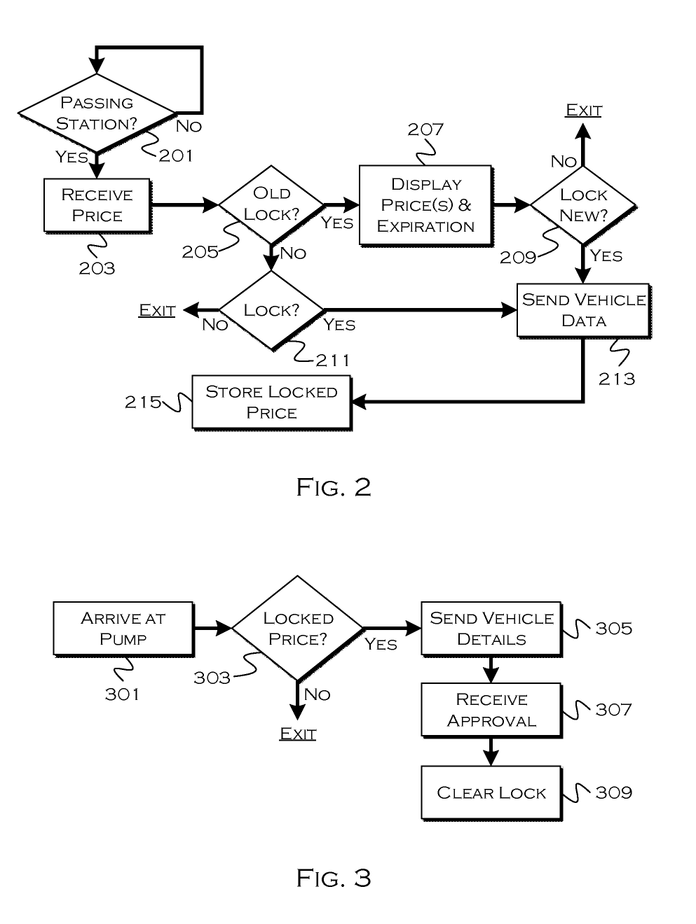

FIG. 2 shows an illustrative example of an offer delivery process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a vehicle may be equipped with a DSRC module and a human machine interface (HMI). The gas station may also be equipped with a DSRC module, which can broadcast messages to passing vehicles and/or receive requests or opt-in notification from passing vehicles.

In this example, when a vehicle is passing a gas station, 201, it may send a notice to the gas station that the vehicle is “opting-in” to price locking. In other examples, the gas station may broadcast a signal advertising a particular price, and the vehicle can receive this signal if it is configured to respond to such signals.

In this example, as the vehicle passes the station, it receives a current price of fuel from the DSRC module in the gas station 203. The process first checks to see if a current price of fuel is already locked in 205. If there is no current price locked in for that particular station 205, the process will determine (perhaps by asking a user, or perhaps automatically) to “lock” and store the fuel price for that station. The process may be capped (by design or by user configuration) as to how many prices can be locked in, and station owners may also only want one price per station locked in (so as to avoid the repeat of the current scenario, where a user is constantly waiting to see if the price gets better). If the lock is confirmed 211, the process will send the vehicle data (such as a VIN or other identifying information) to the station 213 so that the station can secure the offer for that vehicle. In this example, the offer is on a per vehicle basis, so a driver cannot use the offer with another vehicle, although accommodation for such a situation could be made (using, for example, a mobile number or other portable identifier to lock in the information).

Also, in this example, the process stores the “locked” gas price locally on the vehicle 215. This allows the user to view current offered prices from one or more locked stations when the user is out of communication range with the stations. Which means that if the user needs fuel, the user can review the various options before deciding which station to travel to for refueling.

If there is already an existing offer from the current station 205 (or if a total number of allowed locked prices is exceeded), the process will display the current price for that station and the expiration date of the price 207. In the “too many locked” scenario, the process may display all current locked prices and expiration dates, allowing the user to select one for replacement with the new offer.

If the user elects to lock in the offer 209, the process will replace the old offer or another selected offer with the new offer 215, and send the vehicle data (or other identifying data) to the station 213.

One example of how this might operate is as follows. A driver drives past a Gassy Gas station on Monday, and receives an offer of $2.99 per gallon, valid for 7 days. The driver, having no other locked price for this station, accepts the lock and the price is locked until the following Monday. On Saturday, the user passes the Gassy Gas station again, and a new offer of $3.00 per gallon is received. If the user cannot stop to refill until the following Tuesday, for example, then the user may elect to lock the new offer because the price could continue to increase through Tuesday, and the user cannot take advantage of the old offer prior to its expiration. On the other hand, the user may elect to ignore the new offer, if the old locked Monday price can be used prior to expiration. This scenario also brings to light some other options for the station, such as offering to cover any reductions in price between when the user uses the option and the expiration of the option, and also changing the price to reflect a weighting based on how long the offer has been pending (which can help station owners accommodate a rapid rise in gas prices).

FIG. 3 shows an illustrative example of an offer redemption process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a vehicle determines that the vehicle has been parked at or in proximity to a refueling pump 301. The process checks to see if there is a current price locked for a current station 303, and if there is, the process assumes that the driver would like to exercise the option (although the confirmation to do so could be expressly requested. Once the offer is to be exercised, the process sends the vehicle details to the gas station 305.

Upon receiving the vehicle details, the station can look up the offer to see if the request is a valid one. The price of fuel may also have been sent, so the station can compare this to the saved offer to ensure that the offer matches. In some instances, the process on the vehicle side may have saved a new offer and then the vehicle may have driven out of range of the DSRC before the station could confirm the offer. To accommodate these situations, the station may have also included a code with the offer that is utilizable in lieu of or in conjunction with a confirmation that the vehicle saved offer matches the station saved offer. In other instances, the price is only saved at the vehicle once the station receives confirmation of the vehicle details and responds affirmatively.

In this example, once the station has validated the offer, the process receives an approval of the price (and presumably the pump is set to the appropriate price). Determining which pump the vehicle is at can be done in a variety of manners, including, but not limited to, near field communication (NFC), explicit driver identification of the pump, and any other suitable manner.

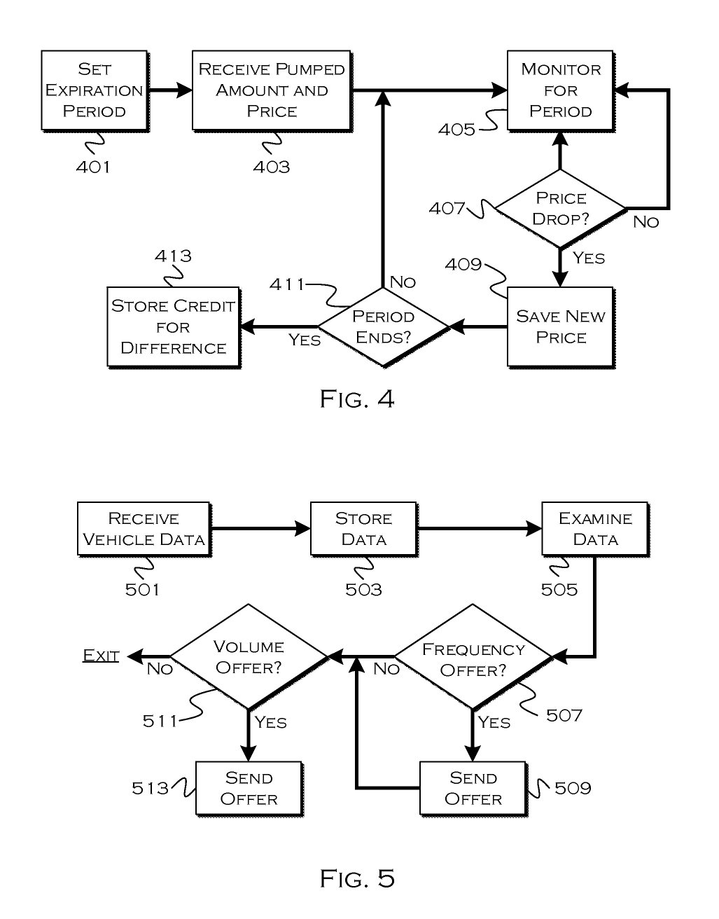

Finally, the vehicle clears the locked price 307, since the offer has been redeemed. Also, at this point in the process, and credit the user has at the gas station may also be redeemed for the present purchase. FIG. 4 shows an illustrative example of an offer update process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, the process runs on the station side to give the customer a “credit” for any change in price between a pumped date and an offer expiration. That is, in order to incentivize a driver to “act now,” a station may choose to honor the lowest price for the period of an offer (i.e., the locked price). While the credit could be a refund, it may incentivize return customers if the station stores the credit to be applied against future purchases. This should always keep customers returning to take advantage of any credits that they may have stored.

Here, the process sets a date corresponding to the expiration date of the offer 401. This defines the period for which the lower price will be offered. Next, the process receives an amount of fuel pumped and a price per gallon 403. This data is stored for the determination of what amount of credit is due if there is a drop from the paid price to a new, lower price. For the duration of the time period, ending on the saved expiration date, the process will monitor the price 405. Since gas stations typically only change prices once or twice a day, there may not be a need to constantly monitor the price, and merely to check all existing customer's files when a price change is registered.

If the new price is lower than the paid price 407, for a given customer record, the process will save the new price 409. In this example, the credit is not issued at the time of the drop, because the price could still drop lower. In another example, the credit may be issued at each drop, storing the new price as the “paid” price, so the customer doesn't have to wait until the expiration period passes before redeeming any intermittent credit. Here, once the expiration period ends, the credit for the difference in prices paid versus the lowest price is stored 413, usable by the customer on the next purchase. In some examples, if sufficient time exists, this credit may also be broadcast to a vehicle with a future offer (once the vehicle has identified itself, for example), increasing the likelihood of the driver choosing to use the station.

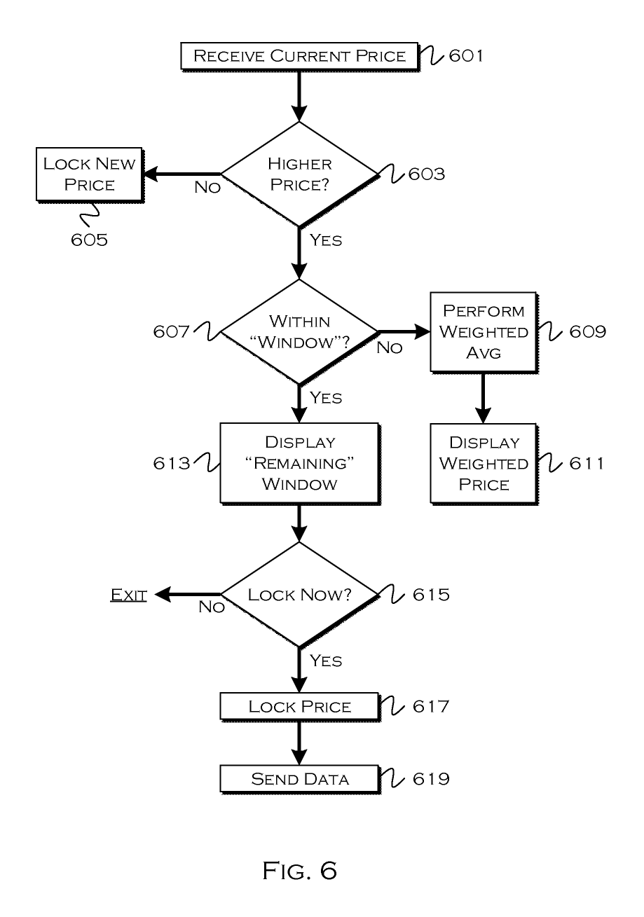

FIG. 5 shows an illustrative example of an offer determination process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In some examples, all of the offers sent to drivers may be the same, and merely reflect the present price of gas. In other examples, the station owner may want to incentivize certain drivers to utilize their particular station. For example, if a vehicle passes a station frequently, the station owner would like that customer to become accustomed to purchasing gas at that station, so the owner may extend a more favorable offer (longer expiration date, better price) to that customer. Also, loyalty rewards are often popular with station owners, so purchasing a certain volume of gas or stopping for a certain number of fill ups over a threshold amount may result in the extension of an expiration date, a drop in price or other rewards. Other scenarios to extend the date or customize the offer are also considered.

In this example, the process receives the vehicle data as the vehicle passes the station 501. This could be in response to an explicit request, or in response to the vehicle locking in the “common” price (as shown in FIG. 2). Here, the data is stored 503, which at a minimum allows the owner to determine how many times a particular vehicle passes the station, and/or how many times a particular vehicle accepts the locked fuel price. The data is examined to determine this an other factors 505. Another time the station receives the vehicle data is in conjunction with a redemption and/or tracking to provide a guaranteed price, so these instances can also be stored, along with a volume of fuel pumped and a total expenditure of money. This data can be analyzed to determine any rewards for volume and or spending at the station.

Any suitable individual data can be stored and saved, as well as analyzed 505. The data can be stored with respect to what action caused the vehicle identification (or user identification) to be received, for easy analysis (e.g., received because of a drive-by, received because of a lock-acceptance, received because of a purchase, etc.). Also, the VIN, at least, can be used to identify the vehicle make and model, so vehicles that use premium fuel and/or have large fuel tanks may receive different offers if the station owner wants to unload premium fuel and/or a large volume of fuel, respectively. Other offers relates to products the station sells and/or that have been purchased in the past can be appended to the deal if desired, based on providing benefits and meeting known purchasing behavior, for example.

In this example, the process determines if a vehicle frequently passes the station 507 based on the number of instances of recorded receipts of vehicle identifying information. If a user identifying information is used, the system can track how many times the user passes the station, in conjunction with or in lieu of vehicle identifying information. If the user meets a frequency threshold, a certain offer encouraging the user to become (or remain) a customer may be extended 509. This can include, but is not limited to, a longer expiration period, a better price, a better price for a shorter expiration period (to create urgency, since the user is commonly passing the station anyhow), etc.

Also, the process determines if the user requires a large volume of fuel 511 (based on a determination of fuel tank size). This determination could also include a type of fuel needed, based on a known specification for refueling a vehicle model. Any offers tailored to volume or fuel blend can then be crafted and/or sent to the particular vehicle as needed 513. The offers can also be dynamic in nature (perhaps formulaic), so that a user may receive a $0.01 per gallon discount for every 10 times the user passes a station within a given week. This can reflect a desirability of obtaining a user who drives past a station so frequently as a regular customer. Offers that reflect a discount or date extension based on loyalty can also be crafted, to reward regular customers. One exemplary method of delivering the offer is to extend the initial offer as the discount, another example would be to “reward” the user for locking in the price by adjusting the date or price as a “reward” after the lock occurs, to incentivize the users to continue to participate in the price locking program.

FIG. 6 shows an illustrative example of an offer adjustment process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, the process will weight the price paid based on a period of time that has passed since the offer was extended. Since station owners pay a varied cost for inventory, natural disasters, wars, and the like can create unexpected spikes in fuel prices. A station owner may not want to sell fuel that costs $3.75 a gallon for $2.75 a gallon simply because an unexpected event happened in the past week. Of course, another option is to “pre-expire” all pending offers in the event of a spike in prices (or adjust the offers), which can be something users agree to when participating in the program.

In this example, the process receives a current price for fuel based on a received DSRC or other wireless signal 601. The system determines if the new price is higher or lower than a previously locked price 603. If the price is lower, the system simply locks in the new price 605 and exits.

On the other hand, if the new price is higher, the process will determine if a “weighting window” has been passed 607. For example, owners may give customers a few days to respond to an original offer before weighting the fuel price, so that the customers aren't placed into a take-it-or-lose-it scenario. (This window can also be set to 0 days, if desired). Thus, in this example, we assume a window of three days for the sake of example.

If three days have not passed since the offer was originally extended, the process displays the amount of time remaining to accept the exact original offer 613. At the time of this window closing, the offered price will not expire, but it will begin to adjust to accommodate the new prices of fuel (assuming those prices are higher). Thus, the longer the customer waits, the more closely to the current price they will pay.

Also, in this example, the customer has an option to simply lock in a present price 615, resetting the window. This may be desirable if the new price is very close to the old price, to extend out both the window and the expiration date. On the other hand, since the customer will lose the old lock if the new lock is taken, the customer may elect to wait and try to use the old price (either within the window or before the expiration of the price). If gas prices jumped significantly, the customer may still prefer the weighted average to the actual new price, even if the window for using the original offer passes.

If the new price is accepted, the process will lock in the new price 617 and send the vehicle data to the station for corresponding recordation of the offer 619.

Once the window has passed, but the offer has not expired, the system will perform a weighted average of the current price and the offered price to obtain a new price 609. This could be a complex equation, or as simple as decaying the old price towards the new price based on how many days had passed (e.g., if four days had passed, the old price gets ¼ weight and the new price gets ¾ weight, if seven days had passed the old price gets 1/7 weight and the new price gets 6/7 weight, as one non-limiting example). By weighting the price, the owner can accommodate rapid rises in fuel prices and, at the same time, can incentivize customers to act within the provided window to ensure the preferred price of fuel. The weighted price (however determined) can then be displayed to the driver 611. Since the weighted price reflects some degree of the locked, lower price, and some degree of the current price, the weighted price will always be lower than the current price, so it still provides an incentive to purchase the fuel.

As one non-limiting example, if a driver received a price of $3.00 on Monday, the driver may have until Wednesday to redeem the offer at $3.00 per gallon. If the price suddenly spiked to $3.50 on Thursday and remained at that price until the following Monday, using the non-limiting weighting equation previously presented, the driver would pay $3.37 on Thursday, $3.4 on Friday, $3.42 on Saturday, $3.43 on Sunday and $3.44 on the following Monday. This still provides an incentive for the driver to use the deal, and also helps the station owner accommodate the rising price of fuel. Of course, in this example, if the fuel jumped to $3.50 on Wednesday, and the driver exercised the option on Wednesday, the driver get the full benefit of the old price. If the station owner wanted to hedge against this, the weighting algorithm could also kick in automatically once a price had risen by a certain amount or percentage. The driver is still incentivized to act sooner rather than later, as the price will continue to rise to reflect the new price, and the schedule of weighting (assuming the price remains the same) could also be shown to the driver to push the urgency.

Through use of the illustrative embodiments, station owners can encourage return of passing drivers, tailor offers to match inventory, and drive a more consistent volume of business, which can encourage lower pricing.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
wirelessly receive and store identification information received from a vehicle, in response to a transmitted fuel offer being wirelessly transmitted to the vehicle; and
provide a price for fuel in accordance with a stored record of the transmitted fuel offer, in response to the vehicle's wirelessly received identification information matching information associated with the stored record.

2. The system of claim 1, wherein the stored identification information includes vehicle identifying information.

3. The system of claim 2, wherein the vehicle identification information includes a vehicle identification number (VIN).

4. The system of claim 1, wherein the stored identification information includes a driver or occupant identification, broadcast by the vehicle.

5. The system of claim 1, wherein stored record includes an expiration date, and the processor is configured to provide the price only if a current date is not past the expiration date.

6. The system of claim 1, wherein the processor is configured to receive a transmitted offer-record from the vehicle, and compare the offer-record to the stored record, to confirm a match between offers associated with each record, before the processor provides the price for fuel.

7. A system comprising:
a processor configured to:
create a record of identification information and a fuel offer, when identification is wirelessly received in response to the processor wirelessly broadcasting the fuel offer to a passing vehicle and a vehicle owner electing to lock-in the offer for a predetermined period.

8. The system of claim 7, wherein the processor is configured to save vehicle identification information included with the identification information as redemption criteria associated with the record.

9. The system of claim 7, wherein the processor is configured to save user identification information included with the identification information as redemption criteria associated with the record.

10. The system of claim 7, wherein the processor is configured to save an expiration date for the record as a date that is the predetermined period from a current date.

11. The system of claim 7, wherein the processor is configured to examine previously stored identification information corresponding to the wirelessly received identification, and broadcast a modified fuel offer based on the identification information identifying an entity entitled to the modified fuel offer.

12. The system of claim 11, wherein the entity is entitled to the modified fuel offer if the previously stored identification information indicates that the entity travels past a station with a predetermined frequency.

13. The system of claim 11, wherein the entity is entitled to the modified fuel offer if the previously stored identification information indicates that the entity has purchased a predetermined volume of fuel.

14. The system of claim 7, wherein the identification information includes a vehicle identification number (VIN).

15. The system of claim 14, wherein the processor is configured to determine a vehicle fuel-needs characteristic based on the VIN, and to broadcast a modified fuel offer based on the fuel-needs characteristic meeting a predefined criteria.

16. The system of claim 15, wherein the predefined criteria includes a recommended fuel blend.

17. The system of claim 15, wherein the predefined criteria includes a fuel tank volume.

18. A system comprising
a processor configured to:
wirelessly receive a fuel offer from a station past which a vehicle travels;
store the offer and an accompanying expiration date in a vehicle memory;
determine that the vehicle is parked at the station based on vehicle location information; and
wirelessly transmit offer identifying information for offer redemption in response to the vehicle being parked at the station.

19. The system of claim 18, wherein the processor is configured to automatically store a better offer in place of a previously stored offer if a price associated with the better offer is lower than a previous price associated with the previously stored offer.

20. The system of claim 18, wherein the processor is configured to request user confirmation before storing a new offer in place of a previously stored offer if a price associated with the new offer is higher than a previous price associated with the previously stored offer.
